(19) United States
(12) Patent Application Publication
(10) Pub. No.: US 2009/0228636 A1
(43) Pub. Date: Sep. 10, 2009

(54) Method for Allocating a Memory

(76) Inventors: Dirk Herrmann, Moeglingen (DE); Jens Liebehenschel, Liederbach (DE)

Correspondence Address: KENYON & KENYON LLP, ONE BROADWAY, NEW YORK, NY, 10004, US

(21) Appl. No.: 12/225,503

(22) PCT Filed: Mar. 14, 2007
(86) PCT No.: PCT/EP2007/052380

§ 371 Date: Mar. 11, 2009

(30) Foreign Application Priority Data
Mar. 24, 2006 (DE) 10 2006 013 765.5

(51) Int. Cl. G06F 12/00; G06F 12/02

(52) U.S. Cl. 711/103; 711/156; 711/E12.001; 711/E12.008

(57) ABSTRACT

In the method for writing into a memory device having a plurality of blocks, the management information of each block and the payload data belonging to the block are stored together.

### FIELD OF THE INVENTION

The present invention relates to a method for allocating a memory, to a memory device, to a computer program, and to a computer program product.

### BACKGROUND INFORMATION

Non-volatile control unit data are stored in EEPROM modules. Different memory layouts or memory designs are used for this purpose. One layout strategy includes dividing the EEPROM into blocks of the same size and storing the actual payload data in these blocks. In addition to these payload data, a piece of management information is needed for each of these blocks. The management information of a block may provide, among other things, information about whether a block is free or allocated, or about the length of the payload data stored in the block, as well as the test data of these payload data, for example, checksum/CRC, and the like. This management information is usually stored in an area of the EEPROM different from that of the payload data area. Therefore, there is one area for the management information and one area for the payload data. This is comparable with the FAT (File Allocation Table) file system for hard disks under Windows. It is also known that a block-oriented EEPROM file system may be used in different control units.

### SUMMARY OF THE INVENTION

In the method according to the present invention for allocating a memory device having a plurality of blocks, management information of each block and the payload data belonging to the block are stored together.

A plurality of blocks is allocated to the memory device according to the present invention in such a way that management information of each block and the payload data belonging to the block are stored together.

All steps of the method according to the present invention are executable using this memory device.

The present invention also includes a computer program having program code means for executing all steps of the method according to the present invention when this computer program is executed on a computer or an appropriate arithmetic unit, in particular on a memory device according to the present invention.

The present invention also includes a computer program product having program code means stored on a computer-readable data medium for executing all steps of the method according to the present invention when the computer program is executed on a computer or an appropriate arithmetic unit, in particular on a memory device according to the present invention.

The memory device may be designed as an EEPROM (Electrically Erasable Programmable Read-Only Memory) or a non-volatile, electronic memory module which is used in embedded systems, for example.

The method and thus a strategy for allocating the memory make it possible to avoid or reduce a capacity loss typically resulting in block-oriented memory devices or file systems due to waste in certain EEPROMs.

The strategy provided with the present invention is therefore suitable for providing a memory allocation or memory layout, a memory planning, or a division of the memory device and may be used on different EEPROM hardware systems. Efficient use of segments of the memory device is thus made possible by a structured or block-wise storage of data, which may contain both management information and payload data, in blocks of the memory device.

The present invention thus provides for the management information of each block to be stored locally together with the payload data or data sets belonging to the block. The payload data of a block may be formed from data including in each case at least one piece of payload data or at least one data set containing file contents. It is now possible to store all files of the particular block together.

Instead of subdividing the EEPROM into two large areas for management information and for payload data, the memory layout or the memory structure may provide for the management information of block 1 to follow the payload data of block 1. This is followed by the management information of block 2, followed by the payload data of block 2, etc., so that the management information of a block n always follows and is thus stored together with the payload data of this block n. In this case it is, however, unimportant whether the management information or the at least one piece of payload data is stored first. Even interlacing between management information and at least one piece of payload data of a particular block is possible.

The advantage of this division results from a technical property of EEPROM hardware: The memory is subdivided into so-called segments in each EEPROM type. To avoid data losses due to power failures when writing to the EEPROM, i.e., the memory device, different data which include the management information and the payload data are separated from each other at the segment boundaries. In the case of unfavorable segment sizes, waste thus arises between two pieces of payload data if the segments cannot be completely filled.

The method provided herein allows for this “waste” to be reduced and thus for the effectively useable capacity of the EEPROM to be increased. Another characteristic of the method is that it is suitable for different segment sizes. The method is therefore applicable to different EEPROM types and thus facilitates the development of a portable, reusable implementation.

The storage of non-volatile payload data which may be typically classified as sensitive may be improved using the method, in particular in control units having memory devices according to the present invention.

In a first example, reference is made to a processor having a segment size of 4 bytes (for example, Freescale HC12); it may be assumed as a possible configuration that the management information occupies 3 bytes per block. The payload data comprise 40 pieces of data, the longest of which have 21 bytes.

The memory layout designed according to the related art may thus have the following aspect: 40 times 1 segment, i.e., 40 times 4 bytes for the management information, resulting in 3 bytes for data and 1 byte waste per block. Furthermore, 40 times 6 segments, i.e., 40 times 24 bytes for the payload data, a block for the payload data having preferably 21 bytes for data and 3 bytes for waste. For shorter data more waste results. All in all, a space of 1120 bytes is needed.

Using the provided method according to the present invention, the memory allocation or memory layout in this case looks as follows: 40 times 6 segments, i.e., 40 times 24 bytes for management information and payload data or data sets. For the longest payload data, a block has 3 bytes of management information and 21 bytes of payload data, i.e., 0 bytes of waste. For shorter data waste results also in this case. All in all, a space of only 960 bytes is needed. In this case, the savings result from the fact that the waste of the management information plus the waste for the payload data is always equal at least to the size of one segment. The combination according to the present invention allows a savings of one segment per block to be achieved.

In a second example, additionally, the option of the payload data being distributed over more than one block is considered. Let the consideration again be based on an HC12 processor and the management information amount to 3 bytes per block. The EEPROM has a total capacity of 1024 bytes. To fully utilize this capacity, a division into 32 blocks having a total of 32 bytes each for management information and payload data could be selected, for example. The memory needed for one piece of payload data having a length of 29 bytes according to the related art would then have 32 bytes for each block subdivided into one segment having 4 bytes for management information and 7 segments having 28 bytes for the payload data. The piece of payload data is divided between two blocks, the first 28 bytes being located in a first block and the last byte being stored in the second block. The following picture results when using the method according to the present invention: The 32 bytes for each block are subdivided into 3 bytes for the management information and 29 bytes for the payload data. One piece of payload data or one data set may thus be stored in a single block. The savings is a complete block, resulting in this example from the fact that the one-byte waste within the management information, which results according to the related art, may be used for accommodating data bytes in the method presented herein.

The present invention, in particular the EEPROM device, may be used in computer systems such as embedded systems, for example so-called body computers; this is also true for future body computers having an EEPROM for storing non-volatile payload data. The present invention may be used in vehicles having control units. The present invention makes it possible to refine block-oriented EEPROM file systems because it ensures good transferability to different EEPROM hardware systems having different properties.

### BRIEF DESCRIPTION OF THE DRAWINGS

FIG. 1 shows a first example of a memory allocation according to the related art.

FIG. 2 shows a first example of a memory allocation according to the present invention.

FIG. 3 shows a second example of a memory allocation according to the related art.

FIG. 4 shows a second example of a memory allocation according to the present invention.

### DETAILED DESCRIPTION

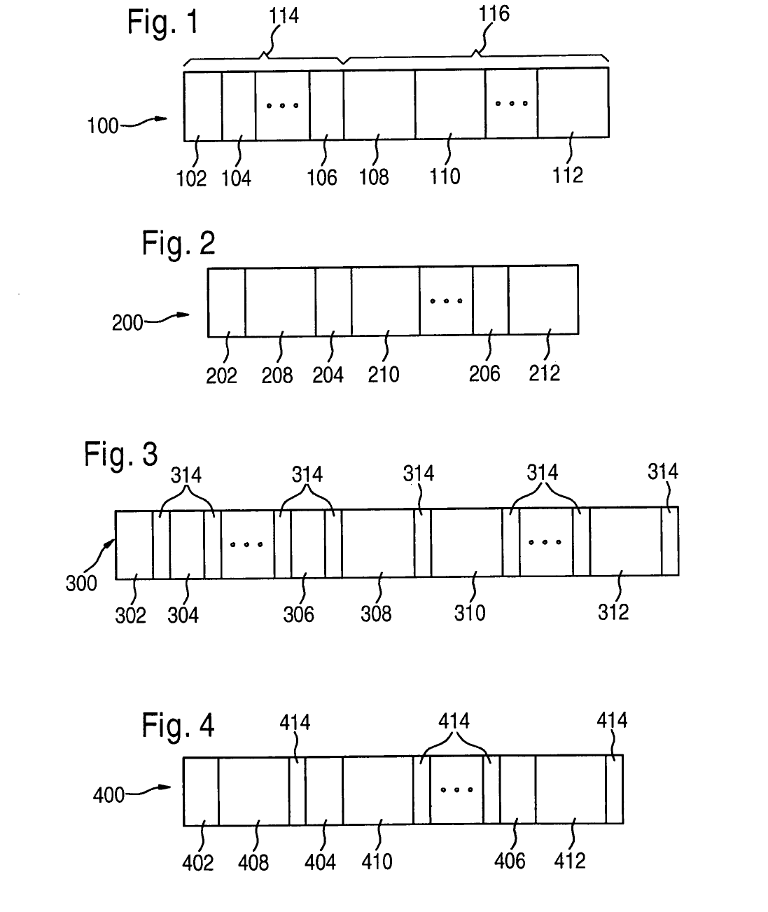

In a block-oriented memory allocation according to the related art, in an EEPROM 100 depicted in FIG. 1, management information 102, 104, 106, and payload data 108, 110, 112 are stored in two areas 114, 116, a first area 114 including the management information 102, 104, 106 for all blocks, and a second area 116 including payload data 108, 110, 112 for all blocks. These two areas 114, 116 follow the same order. In EEPROM 100, which contains n blocks, a structure or a memory design has-the aspect shown in FIG. 1, memory addresses increasing from left to right, Vx being management information 102, 104,106 of block x and Dx being the piece of payload data 108, 110, 112 of block x:

V1 102, V2 104, . . . , Vn 106, D1 108, D2 110, . . . , Dn 112

In contrast, the memory allocation of a memory device 200, depicted in FIG. 2, designed as an EEPROM, in a first example of an application of the present invention provides only one area in which management information 202, 204, 206 and at least one piece of payload data 208, 210, 212 for one block are respectively stored together. In an EEPROM containing n blocks, the following division results, Vx being management information 202, 204, 206 of block x and Dx the at least one piece of payload data 208, 210, 212 of block x:

V1 202, D1 208, V2 204, D2 210, . . . , Vn 206, Dn 212

It is unimportant here whether management information 202, 204, 206 or the at least one piece of payload data 208, 210, 212 is stored first; even interlacing between management information 202, 204, 206 and at least one piece of payload data 208, 210, 212 of a block would be possible.

The advantage of this division results from segmenting memory device 200. A segment is defined by the fact that memory cells may be written to within the segment, without data, which here include management information 202, 204, 206, and payload data 208, 210, 212, within other segments being influenced thereby. In contrast, the data within the same segment are not fully independent of each other.

For the case where the existing EEPROM has a processor having a segment size of 4 bytes, any segment may be modified independently of any other segment. The 4 bytes within the same segment must, however, be handled together. This segment structure of memory device 200 affects the memory structure or memory layout when the data are allocated to memory device 200. When writing to memory device 200, an interruption may occur at any time, for example, because of a power failure. In the case of such an interruption in the write process, the data just written are inevitably lost.

The present invention prevents further data or blocks, which include one piece of management information 202, 204, 206 and the at least one piece of payload data 208, 210, 212 each, from also being damaged. It is provided that two different pieces of data should never share one segment. If one of the two pieces of data is written and therefore changes the shared segment, this prevents an interruption of the write process from damaging both pieces of data when writing to the shared segment. Therefore, each individual piece of data ends at a segment boundary on memory device 200. This may result in waste if a piece of data does not completely fill its segments. A 9-byte long piece of data would occupy three segments having 4 bytes each, for example, in an HC 12; the third segment would be occupied by one byte only, resulting in a waste of 3 bytes.

FIG. 3 shows a second example of a memory structure according to the related art in an EEPROM 300, management information 302, 304, 306 and payload data 308, 310, 312 of one block being separated from each other. A waste 314 occurs here at twice as many locations than in the process according to the present invention on EEPROM 300, and therefore on a medium, since no segment may contain management information 302, 304, 306 of more than one block. Otherwise an interruption in the write process when updating management information 302, 304, 306 of one block would also influence management information 302, 304, 306 of another block. A waste 314 may thus occur between two neighboring pieces of management information 302, 304, 306. In addition, no segment may contain payload data 308, 310, 312 of more than one block; in this way, waste 314 may also occur between two neighboring pieces of payload data 308, 310, 312.

To illustrate this, the memory division for n blocks is depicted in the following, this time, in comparison with FIG. 1, also with all locations where waste 314 may occur with memory addresses increasing from left to right, Vx standing for a piece of management information 302, 304, 306 of block x and Dx standing for a piece of payload data 308, 310, 312 of block x; S stands for a possible waste 314:

V1 302, S 314, V2 304, S 314, . . . , S 314, Vn 306, S 314, D1 308, S 314, D2 310, S 314, . . . , S 314, Dn 310, S 314

FIG. 4 shows a second example of a memory allocation according to the present invention for a memory device 400 designed as an EEPROM. The figure shows memory addresses Vx increasing from left to right for a piece of management information 402, 404, 406 of block x and Dx for at least one piece of payload data 408, 410, 412 of block x; S stands for a possible waste 414.

In this example of the present invention, management information 402,404, 406 and the at least one piece of payload data 408, 410,412 of an individual block are stored contiguously; therefore, a possible waste 414 occurs only between the shared pieces of data, i.e., pieces of management information 402, 404, 406 and payload data 408, 410, 412 of different blocks: The pieces of management information 402, 404, 406 and the at least one piece of payload data 408, 410,412 of the same block share one segment each.

V1 402, D1 410, S 414, V2 404, D2 410, S 414, . . . , S 414, Vn 406, Dn 412, S 414

The present invention may thus increase the effectively utilizable capacity of memory device 400. This is the case where, by combining management information 402, 404, 406 and payload data 408, 410, 412, a waste 414 occurs that is less than in the case of separate storage according to the related art by at least the segment size.

In accordance with 37 C.F.R. § 1.12(b)(3), a Substitute Specification (including the Abstract, but without claims) accompanies this Preliminary Amendment. It is respectfully requested that the Substitute Specification (including Abstract) be entered to replace the Specification of record.

1-10. (canceled)

11. A method for allocating a memory device having a plurality of blocks, comprising:
storing together management information of each block and payload data belonging to the block.

12. The method according to claim 11, wherein the management information of each block and the payload data belonging to the block are stored in one segment of the memory device.

13. The method according to claim 11, wherein the management information and the payload data of a first block are delimited by at least one segment boundary from the management information and the payload data of at least one other block.

14. The method according to claim 11, wherein the management information and the payload data are physically stored.

15. The method according to claim 11, wherein the memory device includes an EEPROM.

16. A memory device comprising:
a plurality of blocks for storing together management information of each block and payload data belonging to the block.

17. The memory device according to claim 16, wherein the management information and the payload data are physically stored.

18. The memory device according to claim 16, wherein the memory device is an EEPROM.

19. A computer-readable medium containing a computer program which when executed by a processor performs the following method for allocating a memory device having a plurality of blocks:
storing together management information of each block and payload data belonging to the block.
